(19) United States
(12) Patent Application Publication
(10) Pub. No.: US 2024/0340824 A1
(43) Pub. Date: Oct. 10, 2024

(54) SIDELINK SYNCHRONIZATION SIGNAL BLOCKS

(71) Applicant: QUALCOMM Incorporated, San Diego, CA (US)

(72) Inventors: Kazuki TAKEDA, Minato-ku (JP); Jae Ho RYU, San Diego, CA (US)

(21) Appl. No.: 18/591,585

(22) Filed: Feb. 29, 2024

Related U.S. Application Data
(60) Provisional application No. 63/494,987, filed on Apr. 7, 2023.

(51) Int. Cl. H04W 56/00; H04W 92/18

(52) U.S. Cl. CPC H04W 56/003; H04W 92/18

(57) ABSTRACT

Various aspects of the present disclosure generally relate to wireless communication. In some aspects, a user equipment (UE) may transmit, within a first slot, a first set of sidelink synchronization signal blocks (S-SSBs), each S-SSB of the first set of S-SSBs indicating a respective S-SSB identifier (ID). The UE may transmit, within a second slot, a second set of S-SSBs, each S-SSB of the second set of S-SSBs indicating a respective S-SSB ID. Numerous other aspects are described.

### CROSS-REFERENCE TO RELATED APPLICATION

This patent application claims priority to U.S. Provisional Patent Application No. 63/494,987, filed on Apr. 7, 2023, entitled “SIDELINK SYNCHRONIZATION SIGNAL BLOCKS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for sidelink synchronization signal blocks (S-SSB).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some communications systems, such as in New Radio (NR) frequency range 2 (FR2), as described in more detail herein, a network node may transmit a set of synchronization signal blocks (SSBs) to provide control information to a user equipment (UE). For example, the network node may provide information associated with identifying a timing of a cell, a set of beams available for a cell, or a set of resources available for a cell, among other examples. The network node may transmit up to 64 SSBs using transmit (TX) beam sweeping in FR2. The UE may attempt to detect an SSB and determine, for example, a system frame number (SFN) or a slot boundary associated with a timing for communications in a network.

In a sidelink deployment with a set of UEs, such as a deployment with a source UE and a target UE, the set of UEs may establish synchronization for sidelink communications using a global navigation satellite service (GNSS) timing or a sidelink synchronization signal block (S-SSB) transmitted by a source UE, which may be referred to as a synchronization reference (SyncRef) UE. The set of UEs may perform a layer 2 (L2) (e.g., medium access control (MAC), radio link control (RLC), or packet data convergence protocol (PDCP) layer) unicast link establishment procedure to enable the source UE to transmit to the target UE.

In NR frequency range 1 (FR1), sidelink UEs may not use beamforming for sidelink signals (e.g., for transmission or reception). A sidelink UE, on FR1, may establish synchronization with another UE using a set of configured rules. For example, the a sidelink UE may be pre-configured with a particular rule, of the set of configured rules, and may use the rule to determine a synchronization priority with regard to a set of possible synchronization sources. The set of possible synchronization sources may include a GNSS source, a UE directly synchronized to the GNSS source, a UE indirectly synchronized to the GNSS source (e.g., a UE synchronized to another UE that is directly synchronized to the GNSS source), among other possible synchronization sources. In some examples, a UE may determine a synchronization priority of a detected S-SSB based on a sidelink synchronization signal (SLSS) identifier (ID) and/or a coverage status indication in a physical sidelink broadcast channel (PSBCH).

Further, in FR1, sidelink UEs may use an S-SSB for sidelink synchronization. An S-SSB bandwidth, in FR1, may be 11 physical resource blocks (PRBs) and include a PSBCH (e.g., 11 PRBs and 9 or 7 orthogonal frequency division multiplexing (OFDM) symbols for a normal cyclic prefix (NCP) and/or extended cyclic prefix (ECP) and a first PSBCH symbol being used for automatic gain control (AGC) at a target sidelink UE). The PSBCH may have a 56 bit payload conveying an indication of a time division duplexing (TDD) configuration, a slot index, or a cyclic redundancy check (CRC), among other examples. Further, the S-SSB bandwidth may include a sidelink primary synchronization signal (S-PSS) (e.g., with a length 127 M-sequence repeated on 2 consecutive symbols) and a sidelink secondary synchronization signal (S-SSS) (e.g., a length 127 Gold-sequence repeated on 2 consecutive symbols).

However, in FR2, in contrast to FR1, sidelink UEs may use beamforming to achieve a desired level of sidelink coverage for transmission or reception on sidelink channels. For example, sidelink UEs may use beamforming for S-SSB transmission and reception. Additionally, or alternatively, sidelink UEs may use beamforming for physical sidelink control channel (PSCCH) or physical sidelink shared channel (PSSCH) transmission and reception. Accordingly, FR1 operations for using an S-SSB, which do not include beamforming, may not be applicable for supporting beam operation for initial synchronization and unicast-link operation on FR2.

Various aspects relate generally to using an S-SSB. Some aspects more specifically relate to using an S-SSB in NR FR2 for synchronization, beam pair establishment, and/or L2 unicast link establishment. In some aspects, a sidelink UE (e.g., a source UE) may transmit, in a first slot, a first set of S-SSBs and may transmit, in a second slot, a second set of S-SSBs. In some aspects, a target UE may use one set of S-SSBs for synchronization and/or the other set of S-SSBs for unicast-link beam pairing.

Particular aspects of the subject matter described in this disclosure can be implemented to realize one or more of the following potential advantages. In some examples, by configuring one or more procedures for FR2 S-SSB usage, sidelink UEs may enable beamforming for sidelink transmissions on FR2. In some examples, by enabling beamforming for sidelink transmissions on FR2, sidelink UEs may achieve at least a threshold level of reliability and/or coverage for sidelink communications on FR2.

Some aspects described herein relate to a method of wireless communication performed by a UE. The method may include transmitting, within a first slot, a first set of S-SSBs, each S-SSB of the first set of S-SSBs indicating a respective S-SSB ID. The method may include transmitting, within a second slot, a second set of S-SSBs, each S-SSB of the second set of S-SSBs indicating a respective S-SSB ID.

Some aspects described herein relate to a UE for wireless communication. The UE may include one or more memories and one or more processors coupled to the one or more memories. The one or more processors may be configured to transmit, within a first slot, a first set of S-SSBs, each S-SSB of the first set of S-SSBs indicating a respective S-SSB ID. The one or more processors may be configured to transmit, within a second slot, a second set of S-SSBs, each S-SSB of the second set of S-SSBs indicating a respective S-SSB ID.

Some aspects described herein relate to a non-transitory computer-readable medium that stores a set of instructions for wireless communication by a UE. The set of instructions, when executed by one or more processors of the UE, may cause the UE to transmit, within a first slot, a first set of S-SSBs, each S-SSB of the first set of S-SSBs indicating a respective S-SSB ID. The set of instructions, when executed by one or more processors of the UE, may cause the UE to transmit, within a second slot, a second set of S-SSBs, each S-SSB of the second set of S-SSBs indicating a respective S-SSB ID.

Some aspects described herein relate to an apparatus for wireless communication. The apparatus may include means for transmitting, within a first slot, a first set of S-SSBs, each S-SSB of the first set of S-SSBs indicating a respective S-SSB ID. The apparatus may include means for transmitting, within a second slot, a second set of S-SSBs, each S-SSB of the second set of S-SSBs indicating a respective S-SSB ID.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of beam sweeping, in accordance with the present disclosure.

FIGS. 7A-7C are diagrams illustrating an example associated with using sidelink synchronization signal blocks, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

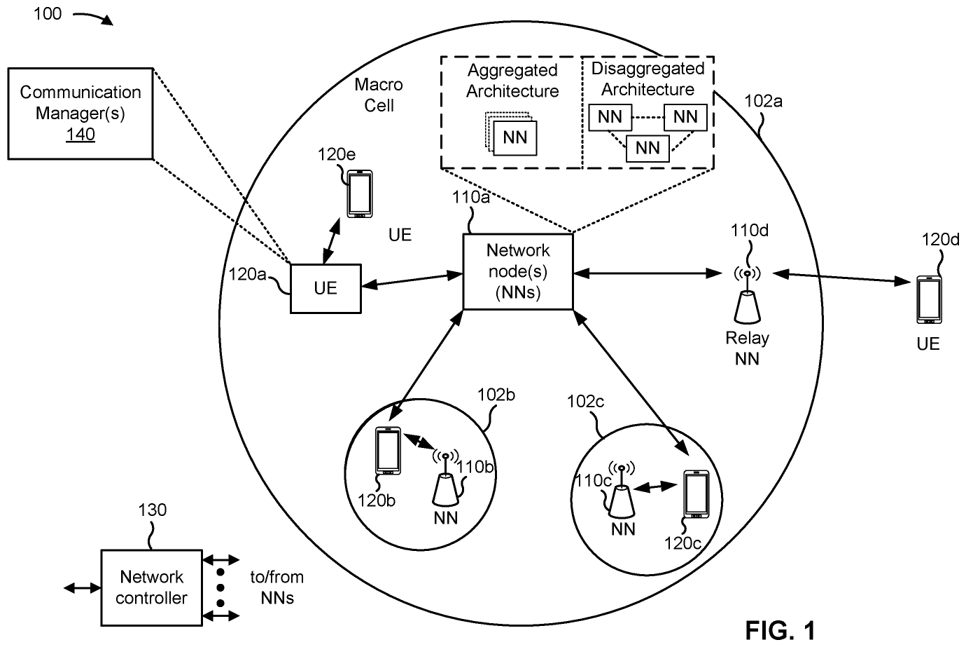

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., one or more memories) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, within a first slot, a first set of sidelink synchronization signal blocks (S-SSBs), each S-SSB of the first set of S-SSBs indicating a respective S-SSB ID; and transmit, within a second slot, a second set of S-SSBs, each S-SSB of the second set of S-SSBs indicating a respective S-SSB ID. Additionally, or alternatively, the communication manager 140 may perform one or more other operations described herein.

As indicated above, FIG. 1 is provided as an example. Other examples may differ from what is described with regard to FIG. 1.

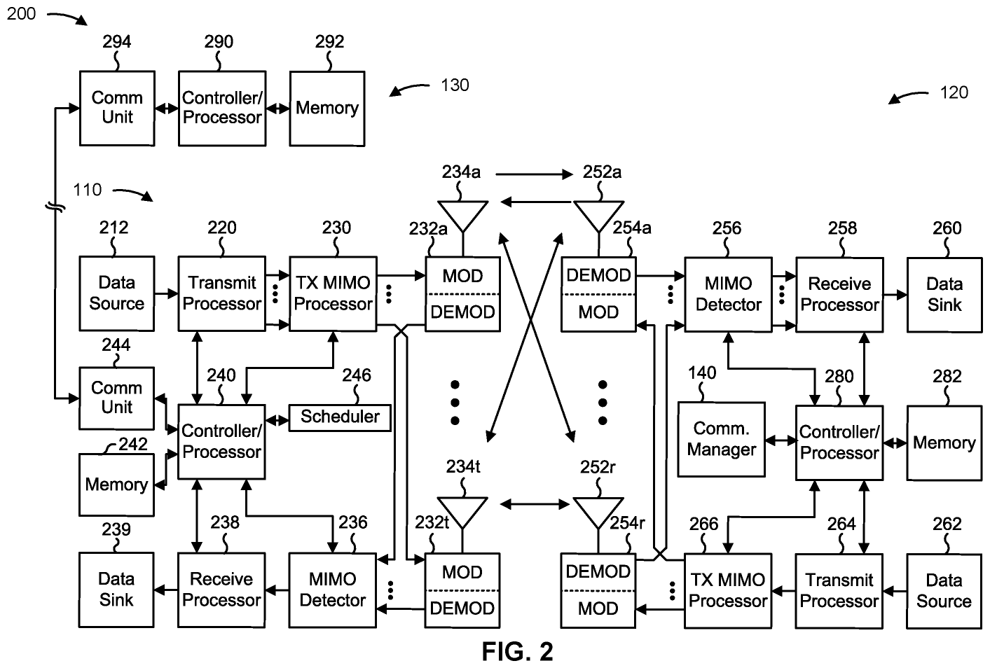

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

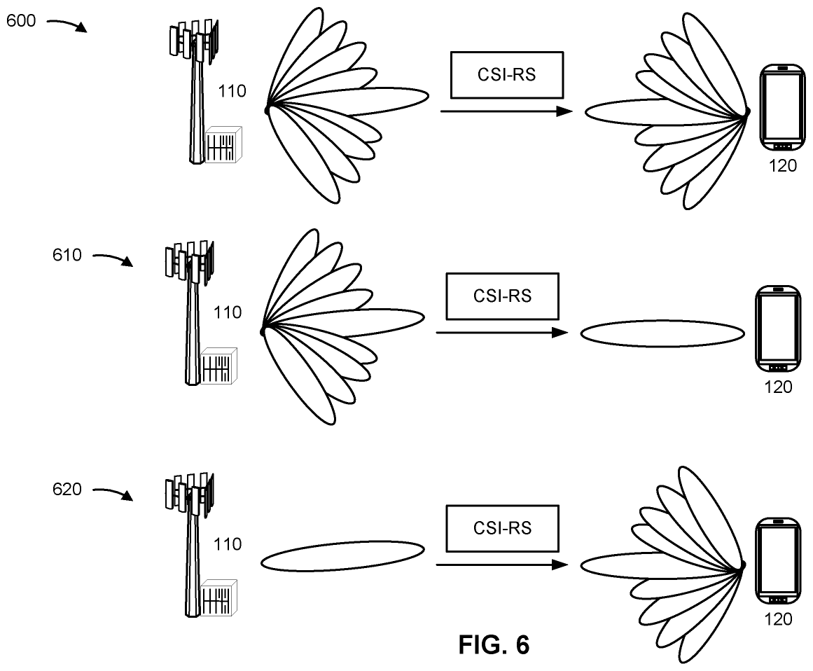

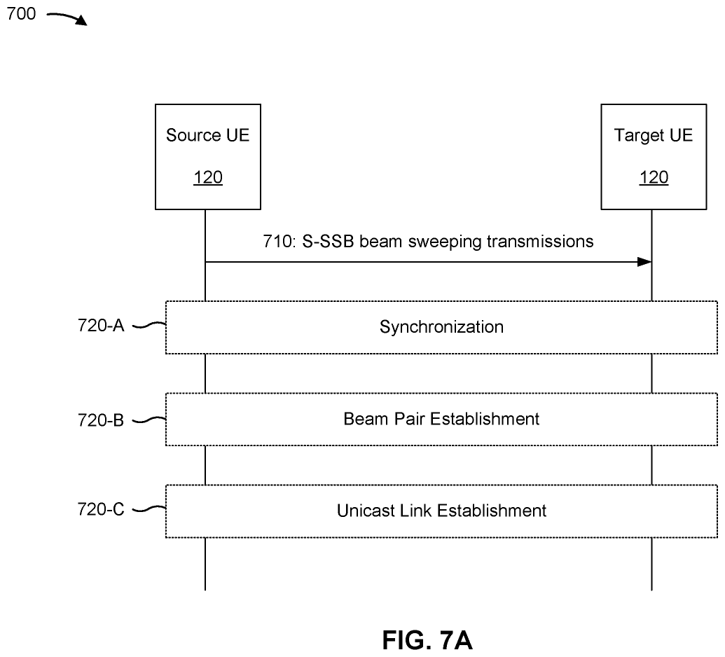

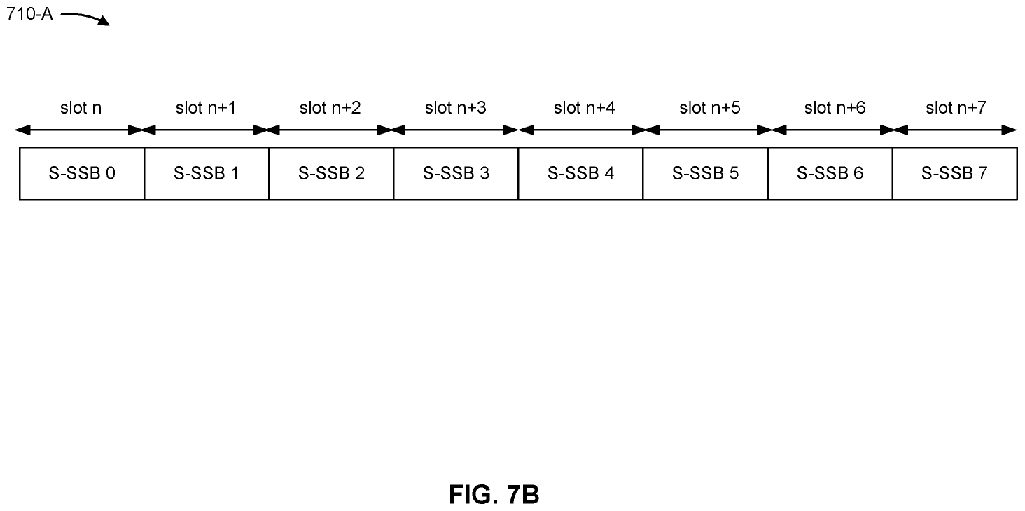

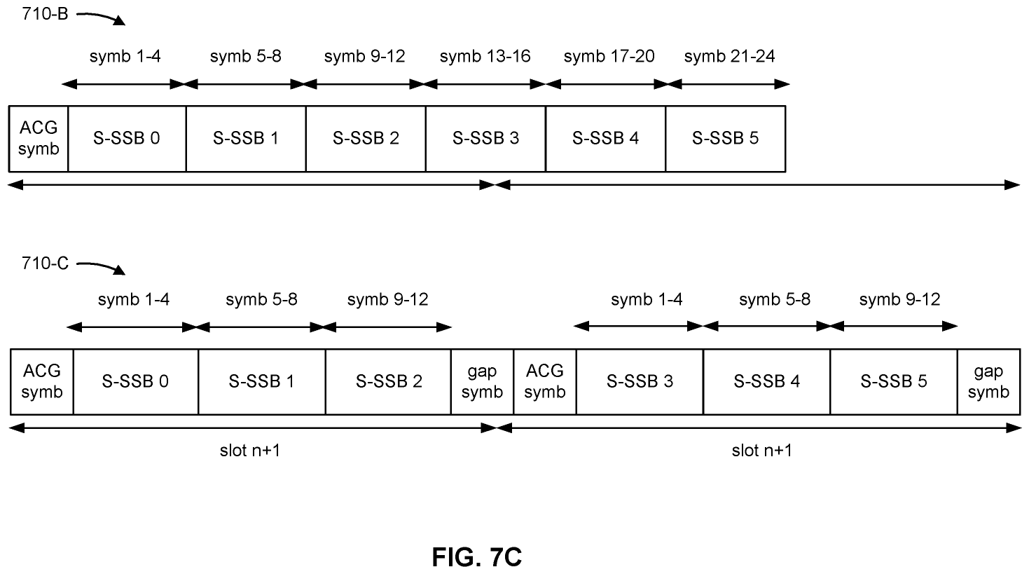

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-7).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-7).

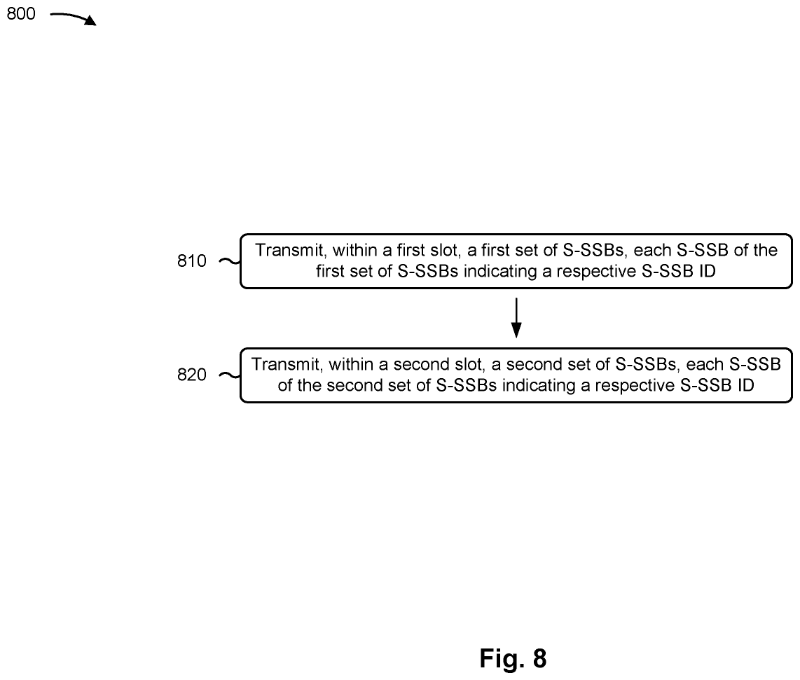

The controller/processor 240 of the network node 110, the controller/processor 280 of the UE 120, and/or any other component(s) of FIG. 2 may perform one or more techniques associated with S-SSBs, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8 and/or other processes as described herein. In some examples, executing instructions may include running the instructions, converting the instructions, compiling the instructions, and/or interpreting the instructions, among other examples.

In some aspects, the UE 120 includes means for transmitting, within a first slot, a first set of sidelink synchronization signal blocks (S-SSBs), each S-SSB of the first set of S-SSBs indicating a respective S-SSB identifier (ID); and/or means for transmitting, within a second slot, a second set of S-SSBs, each S-SSB of the second set of S-SSBs indicating a respective S-SSB ID. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

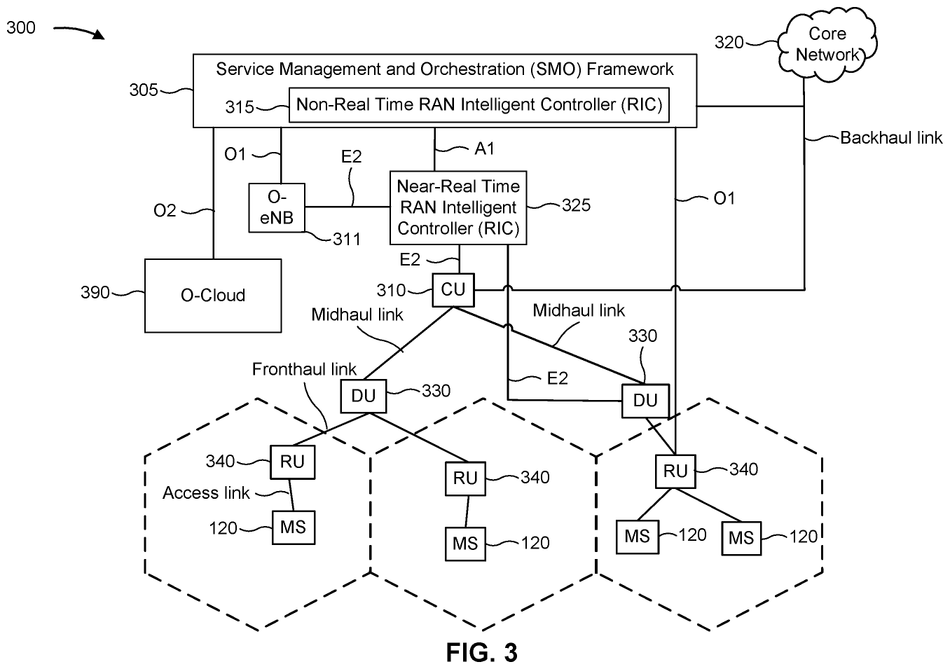

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

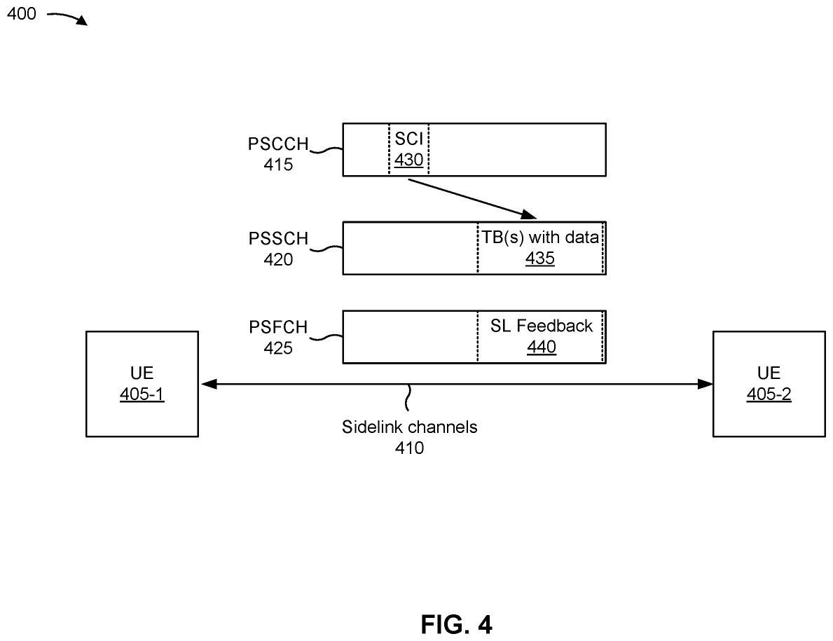

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in an RRC message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

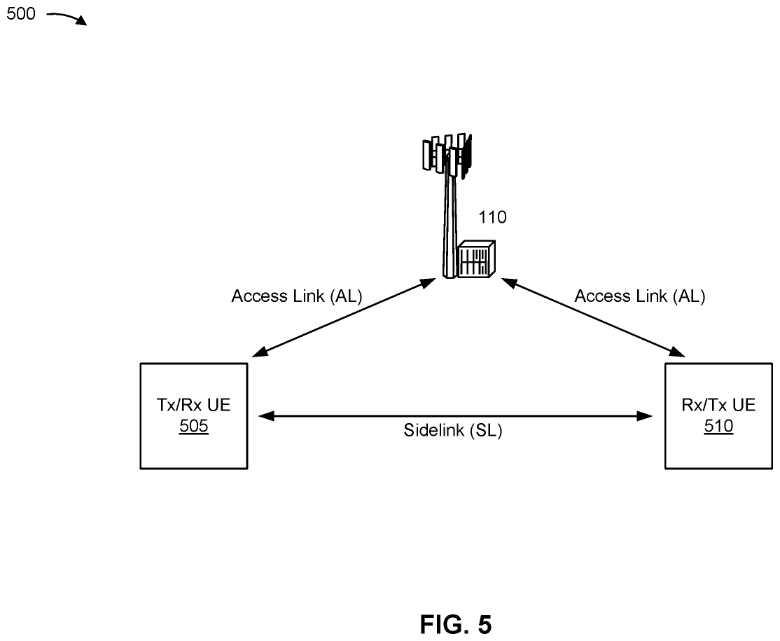

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some networks, the Rx/Tx UE 505 and the Rx/Tx UE 510 may communicate without the access links. For example, one or both of the Rx/Tx UE 505 and the Rx/Tx UE 510 may be outside of a coverage area of the network node and may communicate directly using contention-based resources.

As indicated above, FIG. 5 is provided as an example. Other examples may differ from what is described with respect to FIG. 5.

FIG. 6 is a diagram illustrating examples 600, 610, and 620 of channel state information (CSI) reference signal (CSI-RS) beam management procedures, in accordance with the present disclosure. As shown in FIG. 6, examples 600, 610, and 620 include a UE 120 in communication with a network node 110 in a wireless network (e.g., wireless network 100). However, the devices shown in FIG. 6 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node, among other examples). In some examples, the UE 120 and the network node 110 may be in a connected state (e.g., an RRC connected state).

As shown in FIG. 6, example 600 may include a network node 110 (e.g., one or more network node devices such as an RU, a DU, and/or a CU, among other examples) and a UE 120 communicating to perform beam management using CSI-RSs. Example 600 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 6 and example 600, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 600 has been described in connection with CSI-RSs, the first beam management process may also use SSBs for beam management in a similar manner as described above.

As shown in FIG. 6, example 610 may include a network node 110 and a UE 120 communicating to perform beam management using CSI-RSs. Example 610 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 6 and example 610, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 6, example 620 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 6 and example 620, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 6 is provided as an example of beam management procedures. Other examples of beam management procedures may differ from what is described with respect to FIG. 6. For example, the UE 120 and the network node 110 may perform the third beam management procedure before performing the second beam management procedure, and/or the UE 120 and the network node 110 may perform a similar beam management procedure to select a UE transmit beam.

In a sidelink deployment with a set of UEs, such as a deployment with a source UE and a target UE, the set of UEs may establish synchronization for sidelink communications using a global navigation satellite service (GNSS) timing or a sidelink synchronization signal block (S-SSB) transmitted by a source UE, which may be referred to as a synchronization reference (SyncRef) UE. The set of UEs may perform a layer 2 (L2) (e.g., medium access control (MAC), radio link control (RLC), or packet data convergence protocol (PDCP) layer) unicast link establishment procedure to enable the source UE to transmit to the target UE.

In NR frequency range 1 (FR1), sidelink UEs may not use beamforming for sidelink signals (e.g., for transmission or reception). A sidelink UE, on FR1, may establish synchronization with another UE using a set of configured rules. For example, a sidelink UE may be pre-configured with a particular rule, of the set of configured rules, and may use the rule to determine a synchronization priority with regard to a set of possible synchronization sources. The set of possible synchronization sources may include a GNSS source, a UE directly synchronized to the GNSS source, a UE indirectly synchronized to the GNSS source (e.g., a UE synchronized to another UE that is directly synchronized to the GNSS source), among other possible synchronization sources. In some examples, a UE may determine a synchronization priority of a detected S-SSB based on a sidelink synchronization signal (SLSS) identifier (ID) and/or a coverage status indication in a physical sidelink broadcast channel (PSBCH).

Further, in FR1, sidelink UEs may use an S-SSB for sidelink synchronization. An S-SSB bandwidth, in FR1, may be 11 physical resource blocks (PRBs) and include a PSBCH (e.g., 11 PRBs and 9 or 7 orthogonal frequency division multiplexing (OFDM) symbols for a normal cyclic prefix (NCP) and/or extended cyclic prefix (ECP) and a first PSBCH symbol being used for automatic gain control (AGC) at a target sidelink UE). The PSBCH may have a 56 bit payload conveying an indication of a time division duplexing (TDD) configuration, a slot index, or a cyclic redundancy check (CRC), among other examples. Further, the S-SSB bandwidth may include a sidelink primary synchronization signal (S-PSS) (e.g., with a length 127 M-sequence repeated on 2 consecutive symbols) and a sidelink secondary synchronization signal (S-SSS) (e.g., a length 127 Gold-sequence repeated on 2 consecutive symbols).

However, in FR2, in contrast to FR1, sidelink UEs may use beamforming to achieve a desired level of sidelink coverage for transmission or reception on sidelink channels. For example, sidelink UEs may use beamforming for S-SSB transmission and reception. Additionally, or alternatively, sidelink UEs may use beamforming for physical sidelink control channel (PSCCH) or physical sidelink shared channel (PSSCH) transmission and reception. Accordingly, FR1 operations for using an S-SSB, which do not include beamforming, may not be applicable for supporting beam operation for initial synchronization and unicast-link operation on FR2.

Various aspects relate generally to using an S-SSB. Some aspects more specifically relate to using an S-SSB in NR FR2 for synchronization, beam pair establishment, and/or L2 unicast link establishment. In some aspects, a sidelink UE (e.g., a source UE) may transmit, in a first slot, a first set of S-SSBs and may transmit, in a second slot, a second set of S-SSBs. In some aspects, a target UE may use one set of S-SSBs for synchronization and/or the other set of S-SSBs for unicast-link beam pairing.

Particular aspects of the subject matter described in this disclosure can be implemented to realize one or more of the following potential advantages. In some examples, by configuring one or more procedures for FR2 S-SSB usage, sidelink UEs may enable beamforming for sidelink transmissions on FR2. In some examples, by enabling beamforming for sidelink transmissions on FR2, sidelink UEs may achieve at least a threshold level of reliability and/or coverage for sidelink communications on FR2.

FIGS. 7A-7C are diagrams illustrating an example 700 associated with using S-SSBs, in accordance with the present disclosure. As shown in FIGS. 7A-7C, example 700 includes communication between a network node 110 and a UE 120.

As shown in FIG. 7A, and by reference number 710, the source UE 120 may transmit one or more S-SSB beam sweeping transmissions. For example, the source UE 120 may transmit the one or more S-SSB transmissions, toward the target UE 120, using one or more different beams or beam parameters.

In some implementations, the one or more S-SSB transmissions may be associated with a configured resource structure for FR2 sidelink operation. For example, the source UE 120 may use an S-SSB waveform configured for 3GPP Release 16 sidelink for FR2 sidelink operation. In this case, the S-SSB waveform may be associated with a resource structure of 12 symbols×11 physical resource blocks (PRBs). In some implementations, an M S-SSB transmission within an S-SSB burst may occupy M slots. For example, for M=8, as shown in FIG. 7B and by reference number 710-A, the source UE 120 may transmit an S-SSB 0 in slot n, an S-SSB 1 in slot n+1, and an S-SSB 7 in slot n+7, among other examples.

Additionally, or alternatively, the source UE 120 may use an S-SSB waveform configured for NR SSB transmission for FR2 sidelink operation. In this case, the S-SSB waveform may be associated with a resource structure of 4 symbols×20 PRBs. In some implementations, an M S-SSB transmission within an S-SSB burst occupies a set of 4×M consecutive OFDM symbols. For example, as shown in FIG. 7C and by reference number 710-B, the source UE 120 may transmit, after an AGC symbol 0, an S-SSB 0 across symbols 1-4 (of a first slot n), an S-SSB 1 across symbols 5-8 (of the first slot n), and an S-SSB 5 across symbols 21-14 (of a second slot n+1), among other examples. In this example, the source UE 120 may transmit across 3 slots, including 42 OFDM symbols, to accommodate a set of 10 S-SSBs.

Additionally, or alternatively, the source UE 120 may transmit a set of 3 S-SSBs within each slot, such that K slots accommodate a set of 3×K S-SSBs. For example, as shown in FIG. 7B, and by reference number 710-C, the source UE 120 may transmit, in a slot n after an AGC symbol 0, an S-SSB 0 in symbols 1-4, an S-SSB 1 in symbols 5-8, and an S-SSB 2 in symbols 9-12. In this case, the slot n includes a gap symbol 13 before the source UE 120 transmits, in a slot n+1, an AGC symbol 0, an S-SSB 0 in symbols 1-4, an S-SSB 1 in symbols 5-8, an S-SSB 2 in symbols 9-12, and a gap symbol in symbol 13.

In some aspects, the S-SSB may be associated with a particular resource location. For example, the source UE 120 may transmit an S-SSB burst, conveying the one or more S-SSB transmissions, such that the S-SSB burst starts at a system frame (SF) boundary (e.g., a 1 millisecond (ms) boundary. In this example, a direct frame number (DFN) field in a PSBCH associated with the S-SSB burst indicates a radio frame number of a first slot of the S-SSB burst. Further, a slot index field of the PSBCH may be partitioned into a first part and a second part, with the first part being a 4-bit indication of a SF index within a radio frame (e.g., a value 0 to 9) and the second part being a 3-bit indication of 3 most significant bits (MSBs) of an SSB index within the S-SSB burst. In some aspects, the source UE 120 may indicate one or more least significant bits (LSBs) for the SSB index within the S-SSB burst (e.g., if a quantity of S-SSBs within the SSB burst is greater than 8) using a group of reserved bits of the PSBCH or by a demodulation reference signal (DMRS) sequence of the PSBCH. Accordingly, the target UE 120 may derive a slot index and a slot boundary for a synchronization procedure, as described below, based at least in part on a starting SF index of the S-SSB burst and an S-SSB index of a detected S-SSB.

Additionally, or alternatively, the source UE 120 may transmit an S-SSB burst, conveying the one or more S-SSB transmissions, such that the S-SSB burst starts at alternate SF boundaries (e.g., even-numbered, 2 ms boundaries). In this example, the slot index field may include a first part with a 3-bit indication of a SF index within a radio frame a second part with a 4-bit indication of 4 MSBs of an SSB index within the S-SSB burst.

Additionally, or alternatively, the source UE 120 may transmit an S-SSB burst, conveying the one or more S-SSB transmissions, such that the S-SSB burst starts from any slot within a radio frame. In this example, the DFN field in the PSBCH associated with the S-SSB burst indicates a radio frame number of a first slot of the S-SSB burst. Further, the slot index field of the PSBCH indicates a slot number of the first slot of the S-SSB burst. In some aspects, the source UE 120 may indicate the SSB index within the S-SSB burst using a group of reserved bits of the PSBCH and/or by the DMRS sequence of the PSBCH. Accordingly, the target UE 120 may derive the slot index and the slot boundary for a synchronization procedure, as described below, based at least in part on a starting slot index of the S-SSB burst and the S-SSB index of a detected S-SSB. Additionally, or alternatively, the source UE 120 may indicate the SSB index within a slot (e.g., a slot 0 to 2) using a 2 bit indicator, such as by using a set of reserved bits of a PSBCH or by using a particular DMRS sequence of a PSBCH. In this case, the target UE 120 may derive the slot index based on a slot index within the PSBCH and a slot boundary based on an SSB index within a slot.

In some aspects, the source UE 120 may include a value in a stationary beam indication field as an indicator. For example, the source UE 120 may indicate whether a transmit beam used for a set of S-SSBs with a common S-SSB index is the same transmit beam across an S-SSB burst. In this case, the source UE 120 may set a 1 bit field in the PSBCH to indicate the transmit beam. Additionally, or alternatively, the source UE 120 (e.g., a SyncRef UE) may set the 1 bit field as an indicator flag. The target UE 120 may, for example, perform loop averaging (e.g., of an AGC bit, a frequency tracking loop (FTL) bit, and a time tracking loop (TTL) bit) based on detecting the 1 bit field being set as the indicator flag. In contrast, when the 1 bit field is not set as the indicator flag, the target UE 120 may not perform loop averaging to accommodate a transmit beam that may be changing across an S-SSB burst (e.g., such as when the source UE 120 is moving or rotating).

In some aspects, the S-SSB indices, within an S-SSB burst, are partitioned into S-SSB sub-groups (e.g., with 12 S-SSBs being partitioned into 4 sub-groups representing S-SSBs 0 to 2, 3 to 5, 6 to 8, and 9 to 11, respectively). In this case, the source UE 120 may determine which S-SSBs to transmit on a per sub-group granularity. In other words, the source UE 120 may determine to transmit a first sub-group (e.g., S-SSBs 0 to 2) and a second sub-group (e.g., S-SSBs 6 to 8), but not other sub-groups. In some aspects, different source UEs 120 operating in a common area may coordinate and transmit different S-SSB sub-groups. For example, the source UE 120 may exchange synchronization signaling to coordinate which S-SSB sub-groups to transmit to one or more target UEs 120. In some aspects, the source UE 120 may provide an explicit indication of S-SSB sub-groups in a field of a PSBCH. Additionally, or alternatively, the source UE 120 may provide an implicit indication of the S-SSB sub-groups based on which S-SSBs are transmitted. In other words, when the target UE 120 detects an S-SSB of a particular sub-group, the target UE 120 may determine that other S-SSBs of the particular sub-group have been transmitted by the source UE 120. In some aspects, the S-SSB sub-groups are maintained statically. For example, the S-SSB sub-groups may be specified in a specification or configured using static signaling to avoid conflicts between assignments of S-SSBs to sub-groups.

As further shown in FIG. 7A, and by reference number 720, the source UE 120 and the target UE 120 may perform one or more procedures in connection with the one or more S-SSB beam sweeping transmissions. For example, the source UE 120 and the target UE 120 may perform a synchronization procedure 720-A, a beam pair establishment procedure 720-B, or a unicast link establishment procedure 720-C, among other examples. In this case, the target UE 120 may derive control information (e.g., timing information or beam information) from one or more received S-SSB transmissions and may communicate with the source UE 120 to complete one or more procedures. In some aspects, whether the source UE 120 performs a particular type of procedure is based on an availability of a time synchronization source. For example, when GNSS-based time synchronization is available to the source UE 120 and/or the target UE 120, the source UE 120 and/or the target UE 120 may skip the synchronization procedure using the one or more S-SSB beams (and may use GNSS timing for synchronization).

As indicated above, FIGS. 7A-7C are provided as an example. Other examples may differ from what is described with respect to FIGS. 7A-7C.

FIG. 8 is a diagram illustrating an example process 800 performed, for example, by a UE, in accordance with the present disclosure. Example process 800 is an example where the UE (e.g., UE 120) performs operations associated with S-SSBs.

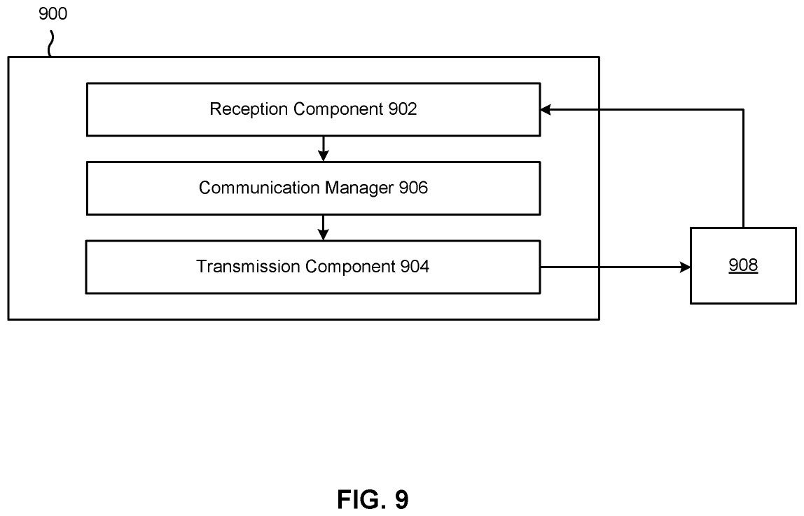

As shown in FIG. 8, in some aspects, process 800 may include transmitting, within a first slot, a first set of S-SSBs, each S-SSB of the first set of S-SSBs indicating a respective S-SSB ID (block 810). For example, the UE (e.g., using transmission component 904 and/or communication manager 906, depicted in FIG. 9) may transmit, within a first slot, a first set of S-SSBs, each S-SSB of the first set of S-SSBs indicating a respective S-SSB ID, as described above.

As further shown in FIG. 8, in some aspects, process 800 may include transmitting, within a second slot, a second set of S-SSBs, each S-SSB of the second set of S-SSBs indicating a respective S-SSB ID (block 820). For example, the UE (e.g., using transmission component 904 and/or communication manager 906, depicted in FIG. 7) may transmit, within a second slot, a second set of S-SSBs, each S-SSB of the second set of S-SSBs indicating a respective S-SSB ID, as described above.

Process 800 may include additional aspects, such as any single aspect or any combination of aspects described below and/or in connection with one or more other processes described elsewhere herein.

In a first aspect, process 800 includes receiving, from an additional UE, beam management information associated with an S-SSB of the first set of S-SSBs or the second set of S-SSBs.

In a second aspect, alone or in combination with the first aspect, the beam management information comprises an indication of a transmission beam for the UE to use in communications with the additional UE.

In a third aspect, alone or in combination with one or more of the first and second aspects, process 800 includes receiving one or more additional S-SSBs from the additional UE, and transmitting, to the additional UE, additional beam management information based at least in part on the one or more additional S-SSBs.

In a fourth aspect, alone or in combination with one or more of the first through third aspects, process 800 includes establishing a unicast link with the additional UE based at least in part on the beam management information and the additional beam management information.

In a fifth aspect, alone or in combination with one or more of the first through fourth aspects, an S-SSB burst that includes the first set of S-SSBs and the second set of S-SSBs comprises an S-SSB that occupies one or more symbols of the first slot and one or more symbols of the second slot.

In a sixth aspect, alone or in combination with one or more of the first through fifth aspects, each S-SSB of the first set of S-SSBs occupies 7 or fewer symbols, or each S-SSB of the second set of S-SSBs occupies 7 or fewer symbols.

In a seventh aspect, alone or in combination with one or more of the first through sixth aspects, a single S-SSB burst includes the first set of S-SSBs and the second set of S-SSBs.

In an eighth aspect, alone or in combination with one or more of the first through seventh aspects, the single S-SSB burst comprises one or more of one or more automatic gain control (AGC) symbols preceding one or more of the first set of S-SSBs or the second set of S-SSBs, or one or more gap symbols following one or more of the first set of S-SSBs or the second set of S-SSBs.

In a ninth aspect, alone or in combination with one or more of the first through eighth aspects, the first set of S-SSBs comprises multiple S-SSBs associated with different transmission beams, or the second set of S-SSBs comprises multiple S-SSBs associated with different transmission beams.

In a tenth aspect, alone or in combination with one or more of the first through ninth aspects, each S-SSB of the first set of S-SSBs indicates a respective S-SSB ID via one or more of a DMRS sequence of a physical sidelink broadcast channel (PSBCH) or one or more reserved bits of the PSBCH, or each S-SSB of the second set of S-SSBs indicates a respective S-SSB ID via one or more of a DMRS sequence of the PSBCH or one or more reserved bits of the PSBCH.

In an eleventh aspect, alone or in combination with one or more of the first through tenth aspects, an S-SSB burst that includes the first set of S-SSBs and the second set of S-SSBs is configured to begin at a subframe boundary, the S-SSB burst is configured to begin at an even subframe boundary, or the S-SSB burst is configured to begin at an odd subframe boundary.

In a twelfth aspect, alone or in combination with one or more of the first through eleventh aspects, an S-SSB burst that includes the first set of S-SSBs and the second set of S-SSBs is configured to begin at a subframe boundary and comprises an indication of whether all S-SSBs with a same S-SSB ID within the S-SSB burst are associated with a same S-SSB beam.

In a thirteenth aspect, alone or in combination with one or more of the first through twelfth aspects, an S-SSB burst that includes the first set of S-SSBs and the second set of S-SSBs is configured to begin at a subframe boundary and comprises an indication of sets of S-SSBs that are included in the S-SSB burst.

In a fourteenth aspect, alone or in combination with one or more of the first through thirteenth aspects, the indication comprises one or more of an indicator within a PSBCH of the S-SSB burst, or implicit indications of the sets of S-SSBs based at least in part on transmission of at least one S-SSB of each of the sets of S-SSBs.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, within a first slot, a first set of S-SSBs, each S-SSB of the first set of S-SSBs indicating a respective S-SSB ID. The transmission component 904 may transmit, within a second slot, a second set of S-SSBs, each S-SSB of the second set of S-SSBs indicating a respective S-SSB ID.

The reception component 902 may receive, from an additional UE, beam management information associated with an S-SSB of the first set of S-SSBs or the second set of S-SSBs.

The reception component 902 may receive one or more additional S-SSBs from the additional UE.

The transmission component 904 may transmit, to the additional UE, additional beam management information based at least in part on the one or more additional S-SSBs.

The communication manager 906 may establish a unicast link with the additional UE based at least in part on the beam management information and the additional beam management information.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting, within a first slot, a first set of sidelink synchronization signal blocks (S-SSBs), each S-SSB of the first set of S-SSBs indicating a respective S-SSB identifier (ID); and transmitting, within a second slot, a second set of S-SSBs, each S-SSB of the second set of S-SSBs indicating a respective S-SSB ID.

Aspect 2: The method of Aspect 1, further comprising: receiving, from an additional UE, beam management information associated with an S-SSB of the first set of S-SSBs or the second set of S-SSBs.

Aspect 3: The method of Aspect 2, wherein the beam management information comprises an indication of a transmission beam for the UE to use in communications with the additional UE.

Aspect 4: The method of Aspect 2, further comprising: receiving one or more additional S-SSBs from the additional UE; and transmitting, to the additional UE, additional beam management information based at least in part on the one or more additional S-SSBs.

Aspect 5: The method of Aspect 4, further comprising: establishing a unicast link with the additional UE based at least in part on the beam management information and the additional beam management information.

Aspect 6: The method of any of Aspects 1-5, wherein an S-SSB burst that includes the first set of S-SSBs and the second set of S-SSBs comprises an S-SSB that occupies one or more symbols of the first slot and one or more symbols of the second slot.

Aspect 7: The method of any of Aspects 1-6, wherein each S-SSB of the first set of S-SSBs occupies 7 or fewer symbols, or wherein each S-SSB of the second set of S-SSBs occupies 7 or fewer symbols.

Aspect 8: The method of any of Aspects 1-7, wherein a single S-SSB burst includes the first set of S-SSBs and the second set of S-SSBs.

Aspect 9: The method of Aspect 8, wherein the single S-SSB burst comprises one or more of: one or more automatic gain control (AGC) symbols preceding one or more of the first set of S-SSBs or the second set of S-SSBs, or one or more gap symbols following one or more of the first set of S-SSBs or the second set of S-SSBs.

Aspect 10: The method of any of Aspects 1-9, wherein the first set of S-SSBs comprises multiple S-SSBs associated with different transmission beams, or wherein the second set of S-SSBs comprises multiple S-SSBs associated with different transmission beams.

Aspect 11: The method of any of Aspects 1-10, wherein each S-SSB of the first set of S-SSBs indicates a respective S-SSB ID via one or more of a demodulation reference signal (DMRS) sequence of a physical sidelink broadcast channel (PSBCH) or one or more reserved bits of the PSBCH, or wherein each S-SSB of the second set of S-SSBs indicates a respective S-SSB ID via one or more of a DMRS sequence of the PSBCH or one or more reserved bits of the PSBCH.

Aspect 12: The method of any of Aspects 1-11, wherein an S-SSB burst that includes the first set of S-SSBs and the second set of S-SSBs is configured to begin at a subframe boundary, wherein the S-SSB burst is configured to begin at an even subframe boundary, or wherein the S-SSB burst is configured to begin at an odd subframe boundary.

Aspect 13: The method of any of Aspects 1-12, wherein an S-SSB burst that includes the first set of S-SSBs and the second set of S-SSBs is configured to begin at a subframe boundary and comprises an indication of whether all S-SSBs with a same S-SSB ID within the S-SSB burst are associated with a same S-SSB beam.

Aspect 14: The method of any of Aspects 1-13, wherein an S-SSB burst that includes the first set of S-SSBs and the second set of S-SSBs is configured to begin at a subframe boundary and comprises an indication of sets of S-SSBs that are included in the S-SSB burst.

Aspect 15: The method of Aspect 14, wherein the indication comprises one or more of: an indicator within a physical sidelink broadcast channel (PSBCH) of the S-SSB burst, or implicit indications of the sets of S-SSBs based at least in part on transmission of at least one S-SSB of each of the sets of S-SSBs.

Aspect 16: An apparatus for wireless communication at a device, comprising a processor; memory coupled with the processor; and instructions stored in the memory and executable by the processor to cause the apparatus to perform the method of one or more of Aspects 1-15.

Aspect 17: A device for wireless communication, comprising a memory and one or more processors coupled to the memory, the one or more processors configured to perform the method of one or more of Aspects 1-15.

Aspect 18: An apparatus for wireless communication, comprising at least one means for performing the method of one or more of Aspects 1-15.

Aspect 19: A non-transitory computer-readable medium storing code for wireless communication, the code comprising instructions executable by a processor to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
transmit, within a first slot, a first set of sidelink synchronization signal blocks (S-SSBs), each S-SSB of the first set of S-SSBs indicating a respective S-SSB identifier (ID); and
transmit, within a second slot, a second set of S-SSBs, each S-SSB of the second set of S-SSBs indicating a respective S-SSB ID.

2. The UE of claim 1, wherein the one or more processors are further configured to:
receive, from an additional UE, beam management information associated with an S-SSB of the first set of S-SSBs or the second set of S-SSBs.

3. The UE of claim 2, wherein the beam management information comprises an indication of a transmission beam for the UE to use in communications with the additional UE.

4. The UE of claim 2, wherein the one or more processors are further configured to:
receive one or more additional S-SSBs from the additional UE; and
transmit, to the additional UE, additional beam management information based at least in part on the one or more additional S-SSBs.

5. The UE of claim 4, wherein the one or more processors are further configured to:
establish a unicast link with the additional UE based at least in part on the beam management information and the additional beam management information.

6. The UE of claim 1, wherein an S-SSB burst that includes the first set of S-SSBs and the second set of S-SSBs comprises an S-SSB that occupies one or more symbols of the first slot and one or more symbols of the second slot.

7. The UE of claim 1, wherein each S-SSB of the first set of S-SSBs occupies 7 or fewer symbols, or
wherein each S-SSB of the second set of S-SSBs occupies 7 or fewer symbols.

8. The UE of claim 1, wherein a single S-SSB burst includes the first set of S-SSBs and the second set of S-SSBs.

9. The UE of claim 8, wherein the single S-SSB burst comprises one or more of:
one or more automatic gain control (AGC) symbols preceding one or more of the first set of S-SSBs or the second set of S-SSBs, or
one or more gap symbols following one or more of the first set of S-SSBs or the second set of S-SSBs.

10. The UE of claim 1, wherein the first set of S-SSBs comprises multiple S-SSBs associated with different transmission beams, or
wherein the second set of S-SSBs comprises multiple S-SSBs associated with different transmission beams.

11. The UE of claim 1, wherein each S-SSB of the first set of S-SSBs indicates a respective S-SSB ID via one or more of a demodulation reference signal (DMRS) sequence of a physical sidelink broadcast channel (PSBCH) or one or more reserved bits of the PSBCH, or
wherein each S-SSB of the second set of S-SSBs indicates a respective S-SSB ID via one or more of a DMRS sequence of the PSBCH or one or more reserved bits of the PSBCH.

12. The UE of claim 1, wherein an S-SSB burst that includes the first set of S-SSBs and the second set of S-SSBs is configured to begin at a subframe boundary,
wherein the S-SSB burst is configured to begin at an even subframe boundary, or
wherein the S-SSB burst is configured to begin at an odd subframe boundary.

13. The UE of claim 1, wherein an S-SSB burst that includes the first set of S-SSBs and the second set of S-SSBs is configured to begin at a subframe boundary and comprises an indication of whether all S-SSBs with a same S-SSB ID within the S-SSB burst are associated with a same S-SSB beam.

14. The UE of claim 1, wherein an S-SSB burst that includes the first set of S-SSBs and the second set of S-SSBs is configured to begin at a subframe boundary and comprises an indication of sets of S-SSBs that are included in the S-SSB burst.

15. The UE of claim 14, wherein the indication comprises one or more of:
an indicator within a physical sidelink broadcast channel (PSBCH) of the S-SSB burst, or
implicit indications of the sets of S-SSBs based at least in part on transmission of at least one S-SSB of each of the sets of S-SSBs.

16. A method of wireless communication performed by a user equipment (UE):
transmitting, within a first slot, a first set of sidelink synchronization signal blocks (S-SSBs), each S-SSB of the first set of S-SSBs indicating a respective S-SSB identifier (ID); and
transmitting, within a second slot, a second set of S-SSBs, each S-SSB of the second set of S-SSBs indicating a respective S-SSB ID.

17. The method of claim 16, further comprising:
receiving, from an additional UE, beam management information associated with an S-SSB of the first set of S-SSBs or the second set of S-SSBs.

18. The method of claim 17, wherein the beam management information comprises an indication of a transmission beam for the UE to use in communications with the additional UE.

19. The method of claim 17, further comprising:
receiving one or more additional S-SSBs from the additional UE; and
transmitting, to the additional UE, additional beam management information based at least in part on the one or more additional S-SSBs.

20. A non-transitory computer-readable medium storing a set of instructions for wireless communication, the set of instructions comprising:
one or more instructions that, when executed by one or more processors of a user equipment (UE), cause the UE to:
transmit, within a first slot, a first set of sidelink synchronization signal blocks (S-SSBs), each S-SSB of the first set of S-SSBs indicating a respective S-SSB identifier (ID); and
transmit, within a second slot, a second set of S-SSBs, each S-SSB of the second set of S-SSBs indicating a respective S-SSB ID.
